(19) United States
(12) Patent Application Publication
(10) Pub. No.: US 2017/0323320 A1
(43) Pub. Date: Nov. 9, 2017

(54) SYSTEMS AND METHODS FOR DETERMINING PRICE COMPETITIVENESS

(71) Applicant: AIRNGURU S.A., Santiago (CL)

(72) Inventors: Sergio Andres MENDOZA COROMINAS, Santiago (CL); Daniel Ivan PIZARRO PIZARRO, Santiago (CL); Pablo Cesar VIVANCO LARA, Santiago (CL)

(21) Appl. No.: 15/589,097

(22) Filed: May 8, 2017

Related U.S. Application Data
(60) Provisional application No. 62/333,790, filed on May 9, 2016.

(51) Int. Cl. G06Q 30/02; G06Q 10/02; G06F 17/24

(52) U.S. Cl. CPC G06Q 30/0206; G06F 17/246; G06Q 10/02

(57) ABSTRACT

Disclosed are methods and systems for obtaining airfare data, analyzing the airfare data in response to user provided parameters, transforming the data into a visual display, and providing the display as a visual representation of competitiveness of a plurality of airfare for one or more first carriers compared to one or more second carriers which are different than the first carriers. The disclosed software provides a useful tool for quickly determining which airfares for a carrier are competitive, not competitive or are overly-competitive. The software can determine competitiveness of a carrier by demand segments, against one or more other carrier(s) and in any particular departure vs. return date combinations, over a wide range of possible date combinations. This allows the airlines to quickly diagnose its competitive position and respond quickly to changing airfare data in order to maintain competitiveness and/or reduce dilution (loss of potential revenues due to prices that are lower than what consumers are willing to pay).

### CROSS-REFERENCE

This application claims the benefit of U.S. Provisional Application No. 62/333,790, filed May 9, 2016, entitled Systems and Methods for Determining Price Competitiveness, which application is incorporated herein by reference.

### BACKGROUND

Currently available airline pricing solutions provide technical and detailed information on airline fares, but they do not provide a comprehensive, single view visualization of how the airlines' fares act on round trips with a plurality of possible combinations of outbound and inbound dates, i.e. on each type of demand segment produced by the price fences in a given origin-destination. Current systems focus on (1) public airfare monitoring, (2) airfare management and (3) airfare distribution tasks. Airfare monitoring typically refers to the capability of identifying, recording and reporting the specific airfare activities and changes performed by all the airlines that file through public systems (like Airline Tariff Publishing Company (“ATPCO”; atpco.net) or SITA (sita.aero)) in a specified market or group of markets.

Airfare management typically refers to the capability of storing and displaying all the details of airfares, searching for and listing airfares applicable to specific markets or groups of markets, specific airlines and other specific features, comparing fares of different airlines, downloading a list of fares displayed on the screens, listing the fare changes that have occurred in a given time period, etc. Airfare distribution typically refers to the capability of editing, modifying, creating, deleting airfares and electronically informing the global distribution systems (GDS's), the on-line travel agencies and the airline website of the airline's updated fares (i.e., “publishing” the fares or fare changes).

As persons of skill in the art will appreciate, market segmentation is an element in the practice of pricing and revenue management (RM) for airlines. After being identified, market segments are typically kept separate to prevent demand spillover from high priced segments to low priced segments and the associated revenue loss. Tools to restrict customer migration across segments are referred to as ‘fences’. See, for example, ZHANG, et al., Price Fencing in the Practice of Revenue Management: An Overview and Taxonomy, J. Rev. Pricing Mgmt. 11L146-159 (2012).

Currently available solutions are typically built on non-scalable technologies which are not cloud based, but rather hosted on airline's premises or on provider's premises, which limits their computational possibilities and increases maintenance costs. Detailed information on these solutions is not openly available, because the systems are proprietary business-to-business (B2B) platforms. These systems are distinguished from consumer systems where a traveler searches for airfare for a flight.

A system available from Sabre—“Sabre AirVision Fare Manager”—offers a broad set of modules and features. Sabre does not specify details in their web page regarding the Fares Manager system, which is focused on management of fares.

Another solution, available from ATPCO, “ATPCO FareManager,” provides a service focused on fare management and distribution, lately including also competitive information. As described on the ATPCO web page, Total Price Comparison provides table, chart and calendar views of price differences against competitors. Total Price Comparison goes only up to 180 days in advance (Competitive Analytics Module optionally covers all possible date combinations allowed by the airlines' itineraries, that is, return dates that are eventually up to one year later than current date).

SITA's “Horizon Fare Management” product is focused on distribution and fare management. The system focuses on fare management, monitoring and distribution.

None of the available solutions provide a matrix visualization of applicable prices and fare rules for round trips in a single view for a plurality of date combinations and a plurality of competitors where competitiveness of pricing can easily be ascertained to provide actionable information real-time or near real-time for a user. What is needed is a system which provides pricing intelligence and real-time or near real-time information about airfare pricing and airlines' price competitive position. What is also needed is a system and method that provides overall visibility and comprehension of the impact of fare fences and fare rules on demand segmentation and price competitive position. Additionally, what is needed is a system which provides a double date entry matrix and graphic view of airfare information and competitive position. Finally, what is needed is a system that provides information on what percentage of the time the published applicable prices are available for sale, whether they are currently available for sale or not, and how do real itineraries and other product attributes along with prices impact the competitive position of an airline.

### SUMMARY

Disclosed is a method for visualizing airfare data in a given origin-destination market, in response to user provided parameters, providing a display which visually represents the competitiveness of the airfare for one or more first carriers (e.g., incumbents) compared to one or more second carriers (e.g., competitors) which are different than the first carriers. The disclosed software provides a useful tool for determining in a single view which airfares for a carrier are competitive, not competitive or are overly-competitive. The tool can provide an exhaustive data comparison over all possible outbound and inbound date combinations or demand segments (e.g., specific combination of outbound vs. inbound dates) in a single view. The software can determine competitiveness of a carrier or group of carriers by one or more demand segments, against one or more other carrier(s) and in any particular departure vs. return date combinations, over a wide range of possible date combinations. This allows the airlines to quickly diagnose its competitive position and respond quickly to changing airfare data in order to maintain competitiveness and/or reduce dilution (loss of potential revenues due to prices that are lower than what consumers are willing to pay).

Described is a system and platform that addresses the following problems: lack of overall visibility and comprehension of the impact of fare fences and fare rules on demand segmentation; lack of overall visibility and comprehension of the impact of fare fences and rules on the applicability of prices over all possible date combinations (outbound vs inbound) and demand segments; lack of overall visibility and comprehension of the impact of fare fences, fare rules and fare levels on the competitive position of incumbent airline vs competitors; lack of visibility of how the competitive position of the incumbent airline changes over time; lack of overall visibility of what percentage of time are the airlines' published prices available for sale and how does this affect their competitive position; lack of overall visibility of how real itineraries affect the airlines' applicable prices and their price competitive position.

In order to optimize prices, a user needs to evaluate optimal price levels and fencing decisions in the context of the competitors, market behavior and demand patterns, by analyzing price levels, price fences, allocated inventories, load factors, itineraries, market shares, booking rates, etc., and applying these decisions to a given situation in order to adjust or readjust its competitive position under changing market conditions (price levels, fences, itineraries, services, capacity strategies etc., of incumbent and competitor airlines).

An aspect of the disclosure is directed to computer-implemented methods for analyzing airline pricing. Suitable methods comprise: (a) receiving a request for a comparison of airline pricing data; (b) identifying a source for the airline pricing data; (c) electronically collecting airline pricing data for at least a first airline and a second airline; (d) comparing the collected airline pricing data to determine a competitiveness of the first airline pricing data to the second airline pricing data; (e) transforming the compared airline pricing data from a numerical format into a non-numerical format based on a set of rules; (f) generating, using a computer, a graphical matrix of the compared airline pricing data having a first axis and a second axis wherein each compared pricing data has a cell within the graphical matrix; and (g) displaying the graphical matrix of compared airline pricing data. Additionally, the method can include comparing the pricing data of the first airline to a pricing data of a third airline. In some configurations, the first axis is a traveling period and the second axis is a number of days advanced reservation; in other configurations the first axis is a return date and the second axis is a departure date. The display can toggle between the traveling period display and the return date display. The method can further comprise filtering the collected airline pricing data. Suitable filtering includes, filtering any of the origin, destination, incumbent carrier, competitor carrier, segment, cabin, airfare, number of stops and departure time. Additional filtering can be based on an airfare and the airfare can be sampled based on a percentage of deviation. Filtering can also be based on an airfare which is sampled based on a window of time. In some configurations, the comparing step can further comprise at least one of comparing the first airline pricing data to the second airline pricing data and a third airline pricing data, comparing the first airline pricing data and the second airline pricing data to a third airline pricing data, and comparing the first airline pricing data and the second airline pricing data to a third airline pricing data and a fourth airline pricing data. Selecting a cell of the matrix can provide the user with a summary of competitive data selected from a price ratio, a lowest incumbent, a lowest incumbent price, a lowest competitor, a lowest competitor price, a departure data and a return data. The data can be provided via a pop-up screen. Additionally, the airline pricing data can comprise at least one of real-time data, and historical data. An algorithm engine can be used to identify a competitive pattern and generates a visual matrix. Additionally, in some configurations, the steps (a) through (g) are executable via the computer or a series of computers. Each cell can also be configurable to represent data from three or more sources. Each cell is also configurable to be expandable to present two or more of a price ratio, a lowest incumbent, a lowest competitor, a departure date and a return date.

Another aspect of the disclosure is directed to a data storage and retrieval system for a computer having a memory, a central processing unit and a display comprising: means for configuring the memory to generate a matrix having a first axis and a second axis, the matrix including a plurality of cells having a display selected from at least one of three choices based on a plurality of attributes wherein the attributes are selected from incumbent airfare, competitor airfare, departure date, departure time, return date, return time, traveling period, and advanced reservation time. The system can include means for assigning a color to each of the plurality of cells based on a calculated competitiveness of at least one incumbent airfare and at least one competitor airfare.

Still another aspect of the disclosure is directed to an apparatus for automatically determining competitiveness of airline pricing data comprising: a computer system; identifying a source for the airline pricing data; electronically collecting airline pricing data for at least a first airline and a second airline; obtaining a first set of rules for comparing the collected airline pricing data to determine a competitiveness of pricing data of the first airline to the pricing data of the second airline; applying, in the computer system, the first set of rules to generate the competitive pricing data; applying, in the computer system, a second set of rules for transforming the compared airline pricing data from a numerical format into a non-numerical format; generating, by the computer system, a graphical matrix of the compared airline pricing data wherein each compared pricing data has a cell and further wherein each cell presents a visual representation of the comparison along a first axis and a second axis; and displaying the matrix of compared airline pricing data. Additionally, the pricing data of the first airline can be compared to a pricing data of a third airline, fourth airline, or plurality of airlines. Additionally, filtering, by the computer system, of the collected airline pricing data can also be performed. Filtering can be selected from, for example, origin, destination, incumbent carrier, competitor carrier, segment, cabin, airfare, number of stops and departure time. Additionally, filtering can be based on an airfare wherein the airfare is sampled based on a percentage of deviation and/or a window of time. An algorithm engine can be used to identify a competitive pattern and generates the graphical matrix. The computer system can also include a series of computers. Each cell can be configurable to represent data from three or more sources. Additionally, each cell is configurable to be expandable to present two or more of a price ratio, a lowest incumbent, a lowest competitor, a departure date and a return date.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example,

US 2014/0310066 A1 to Etzioni published Oct. 16, 2014 for Performing Predictive Pricing Based on Historical Data;

US 2015/0161636 A1 to Williams published Jun. 11, 2015 for Method and Server for Providing a Set of Price Estimates, such as Airfare Price Estimates;

US 2016/0092898 A1 to Wang published Mar. 31, 2016 for Intelligent Pricing;

U.S. Pat. No. 8,694,346 B2 to Crean issued Apr. 8, 2014 for Travel-Related Prediction System;

U.S. Pat. No. 8,712,920 B2 to Walker issued Apr. 29, 2014, for Method and Apparatus for a Cryptographically Assisted Network System Designed to Facilitate Buyer-Driven Conditional Purchase Offers;

U.S. Pat. No. 8,732,066 B2 to Walker issued May 20, 2014, for Method and Apparatus for Facilitating a Transaction Between a Buyer and One Seller; and

ZHANG, et al., Price Fencing in the Practice of Revenue Management: An Overview and Taxonomy, J. Rev. Pricing Mgmt. 11L146-159 (2012).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a portion of a screen shot illustrating a “competitive position matrix” in a “segment view” for a snapshot of 0-31 days×0-31 days;

FIG. 1B is a portion of a screen shot illustrating a competitive position matrix in a “calendar view;”

FIG. 1C is a portion of a screen shot illustrating a 365 view with a zoom-out of a segment view of FIG. 1A;

FIG. 1D is a portion of a screen shot illustrating a 365 view with a zoom-out of a calendar view of FIG. 1B;

FIG. 1E illustrates view selection buttons for segment, calendar and 365 view;

FIGS. 2A-B illustrate color spectrum which would be viewable by a color-blind user and other spectra options in a competitive position matrix;

FIG. 3 is an advanced filter, that allows a visualization at the RBD and/or fare class level, in order to analyze price competitive position in low cost markets (e.g., markets with weak fare fences or no fare fences at all);

FIG. 4A illustrates a dynamic link; FIG. 4B illustrates a filter;

FIGS. 5A-C illustrates a minimum stay rule (FIG. 5A), an advanced reservation rule (FIG. 5B) and an intersection of rules along with the resulting price range within the matrix (FIG. 5C);

FIG. 6A illustrates a full screen shot of a competitive analytics module; FIG. 6B is the design of a version of competitive analytics module, including additional filters (in the filter section) and additional output information (in the price list section);

FIG. 7 illustrates an enlargement of a competitive matrix tooltip;

FIGS. 8A-C illustrate a filter section of competitive analytics. The filter section of competitive analytics offers the user a variety of filters and options to build the prices for round trips, these filters and options include at least types of fares and combinations, cabins, itinerary types (non-stops, half stops, one stops, etc.; user can de-select itinerary option to evaluate prices assuming there is always and only a nonstop itinerary available per airline), departure time windows, fare data sources (published fares data, lowest available fares data, etc.; selecting two or more data sources produces an “intersection” of data sources useful for certain analysis), airport taxes, etc.;

FIG. 9 illustrates a price list section of competitive analytics; this section may include, for the selected cell in the competitive position matrix: the applicable prices, the associated fare classes that compose each of the prices, the percent availability of each of the prices, the itineraries to which each of the prices applies, the length of the trips in hours, other attributes of the product, etc. User can select one or more fares. A price range pop-up can be displayed which provides a range of fares for a selected airfare.

FIG. 10A illustrate a portion of a screen shot with competitive analytics module comparing one incumbent airline's lowest prices against one competitor's lowest prices in each demand segment, for all possible outbound and inbound dates combinations, for a selected origin-destination.

FIG. 10B illustrate a portion of a screen shot with competitive analytics module comparing an incumbent airlines' lowest prices against several competitors' lowest prices in each demand segment, for all possible outbound and inbound dates combinations, for a selected origin-destination.

FIG. 10C illustrates a portion of a self-compare matrix screen shot 1020 with competitive analytics module comparing an incumbent airlines' lowest price in each demand segment against its lowest price across all demand segments, for a selected origin-destination.

FIGS. 11A-C illustrate screen shots of segment and calendar views of competitive analytics module for visualization of price competitive position and drilling down of a specific demand segment (FIG. 11A and FIG. 11C);

FIG. 12 illustrates a detailed view of the fare data, its fare rules (as published by the airlines through ATPCO) with text transcriptions and the graphical segmentation interpretation when applicable; and

FIG. 13 illustrates a view of the fare data and fare visualization with tools.

### DETAILED DESCRIPTION

The disclosed solution to the price competitive position visualization problem has several key advantages over existing technology used for pricing intelligence applications. The system is configurable to evaluate all fares for all carriers that have published fares in any given origin-destination market, at the current moment in time or at a given moment of time in the past in a very short time (seconds) at an accessible cost. The disclosed solution provides a single view visualization of competitiveness in a given origin-destination market of a plurality of airfares based over a plurality of combinations of inbound and outbound dates, or reservation days in advance and days of trip.

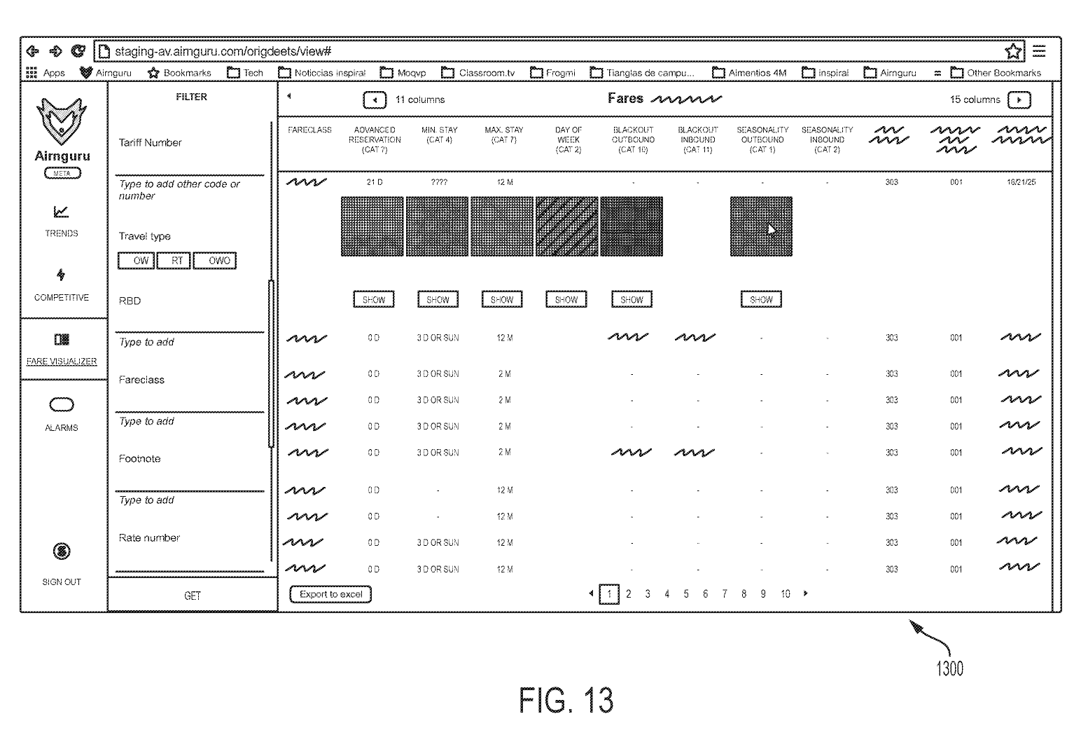

The disclosed systems and methods provide a comprehensive visualization of relevant current price information and competitive price position to a user, in a single graphical user interface (GUI) dashboard 1300 shown in FIG. 13, of a plurality of combinations of travelling dates (outbound vs. inbound) up to a year before departure (optionally, up to less than a year before departure) for any selected origin-destination pair. The departure date time frame can start on the sales date and a default sales date and time can be the date and time of the latest available fare data. Historic views of prices and price competitive positions can be provided when user selects a past sales date and time; the prices and competitive positions displayed in historic views are the prices that were current at the selected date and time of sales.

The prices computed and visualized in a competitive analytics module can be presented as “all-in” prices, to include all price components, among others, the carrier imposed “YQ/YR” fee (which provides a standardized automated collection, distribution and pricing method for fuel and carrier-imposed fees), the airport taxes, etc.

The applicable prices in a competitive analytics module, with all their components (including the YQ/YR fee), can be computed incorporating the effect of real or hypothetical itineraries of incumbent airlines and competitors. User itinerary choices can include non-stop itineraries, “half-stop” itineraries (one stop in one of the two directions of a round trip), one-stop itineraries (one stop in each of the two directions of a round trip), etc.

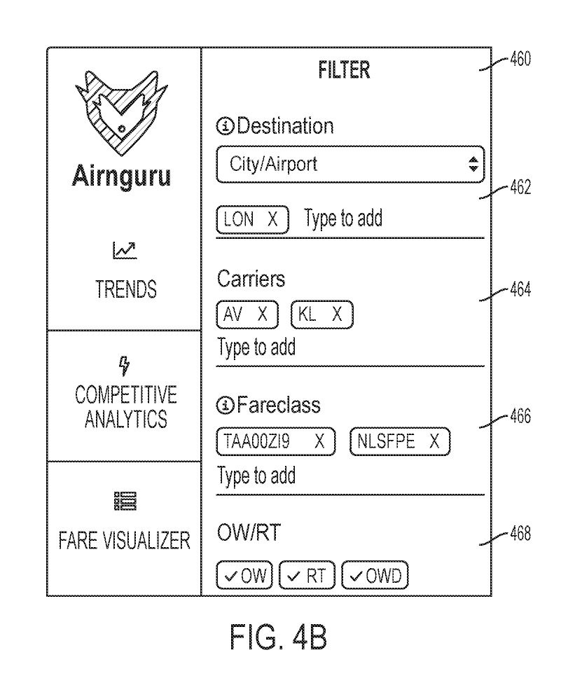

Drill down capabilities into particular components of the airfare data can be complemented with dynamic links (FIG. 4A) which allow the user to select specific prices in each combination of dates and in a single mouse click export the selected data along with the rest of the filters into other modules of the software, substantially increasing the productivity of the users.

Graphical comprehension of the impact of each airfare fence on each possible combination of out-bound dates and inbound dates is provided, along with the integrated impact of all the fare fences and all the details of the selected fares. Airfare fences are rules that are used to apply an airfare to a particular flight. These rules can cover advanced purchase time (e.g., 14 day advance purchase), minimum stay, departure day requirements, flight time requirements, maximum stay, travel windows, purchase date, flight restriction, blackout dates, and surcharges.

Multiple options and filtering capabilities for reservation booking designators (RBD), airfare classes, types of airfares, cabins, types of itineraries, departure time windows, etc. can also be provided; in particular, RBD and/or airfare class filters may be used to ascertain price competitive position in low cost markets (markets with weak or with no fare fences).

Multiple price data sources can be selected by the user and provided by competitive analytics module (for example, published fares, lowest available fares, etc.) either to display prices computed from any of these sources separately or to mix these sources in any reasonable manner that adds value to the user, for example, providing the user with information of the percentage of the lowest available airfare sample in which the published airfare showed available for sale in a given sales time range.

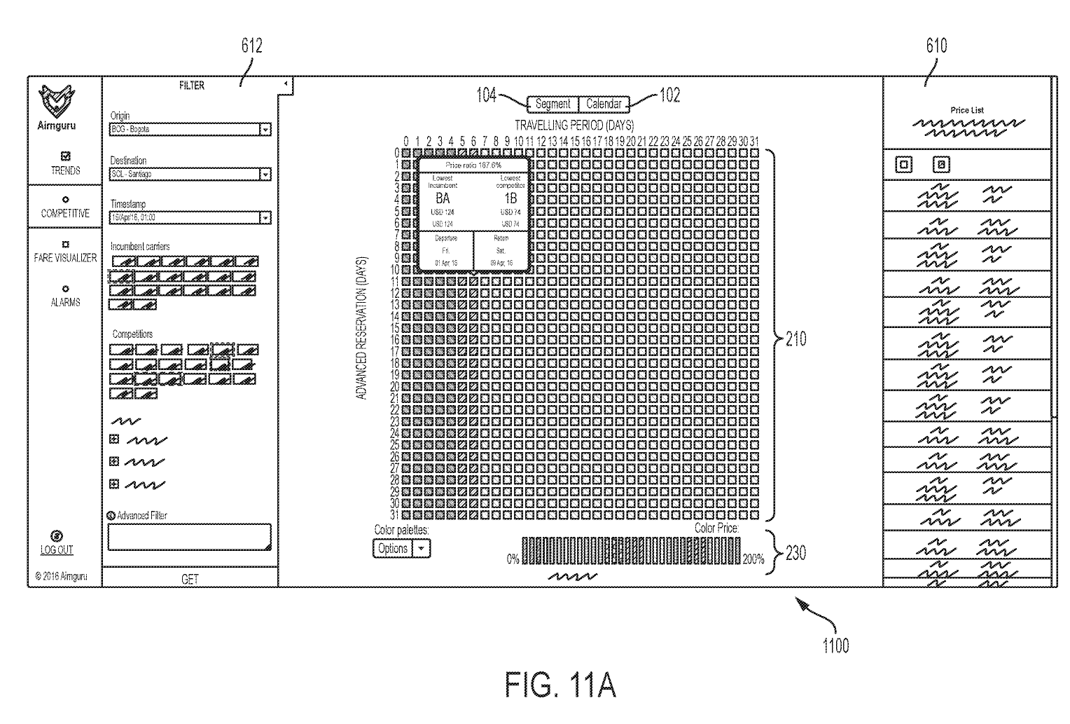

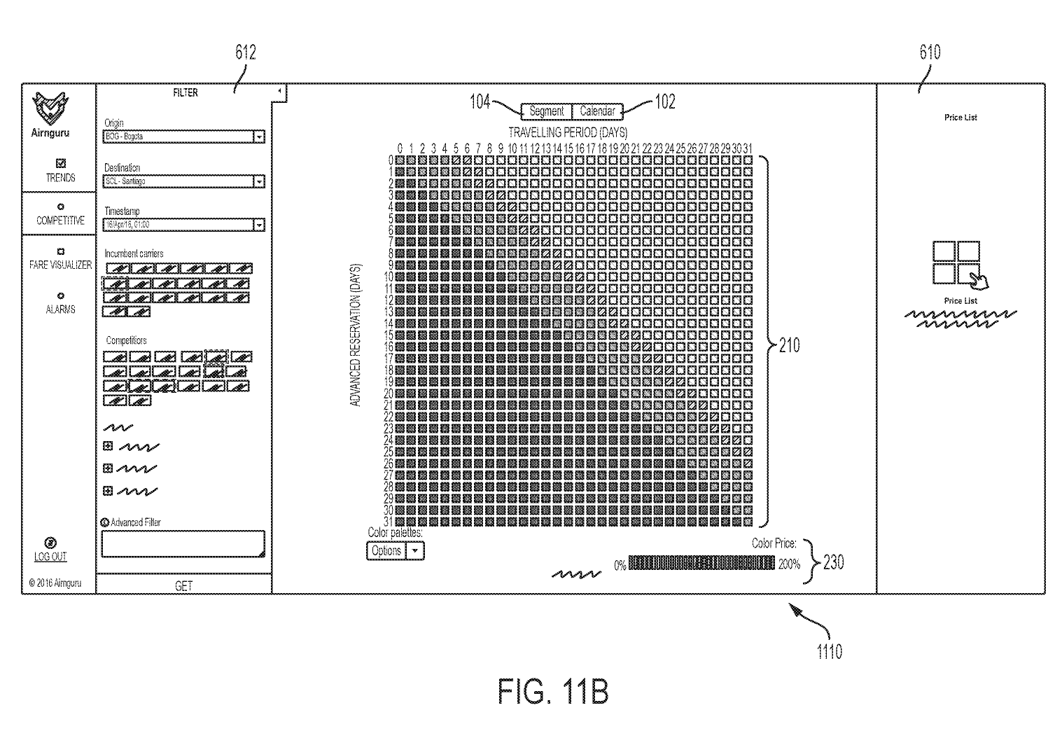

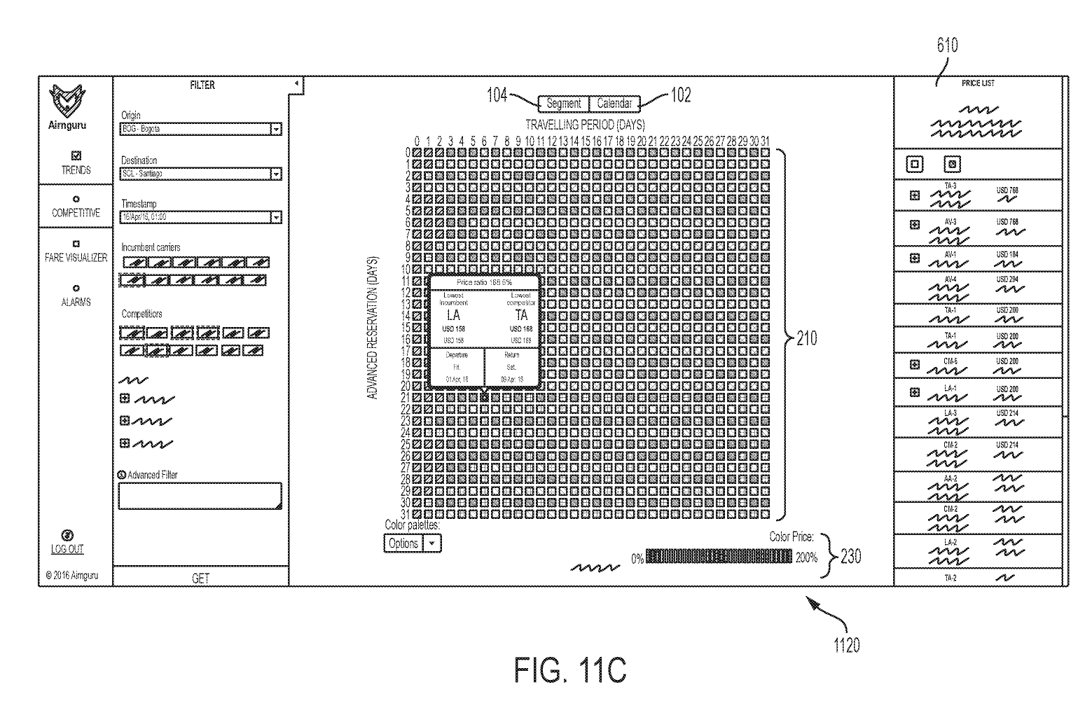

Through a competitive analytics module the data is transformed to allow a user, such as a revenue management or pricing specialist, to use the information to quickly discover opportunities to generate extra revenues by increasing competitiveness or reducing dilution in a given origin-destination market. The transformation of the data into useful displayed information is achieved through the use of three sections within the module (see FIG. 11C):

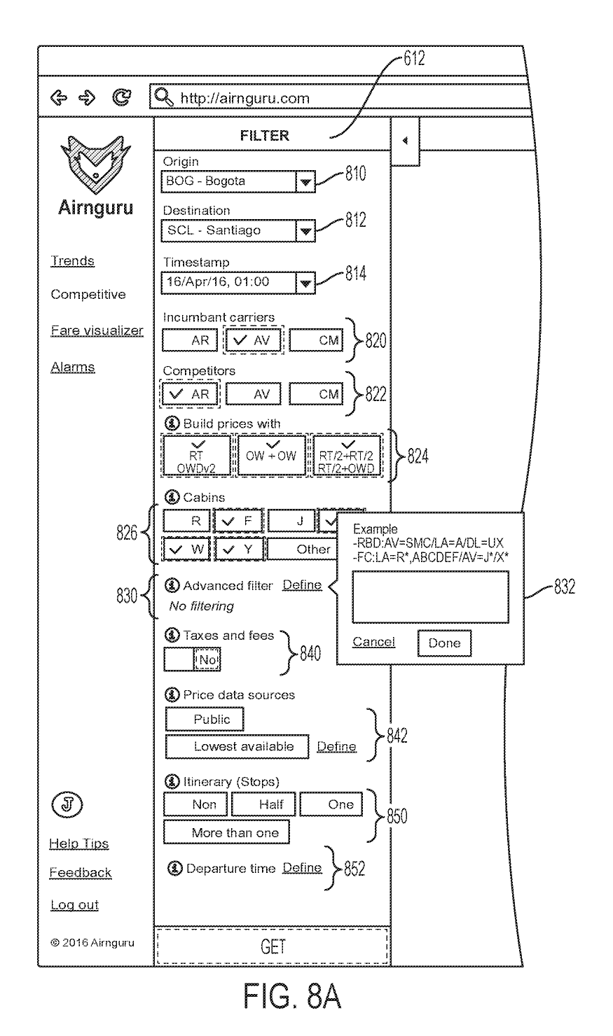

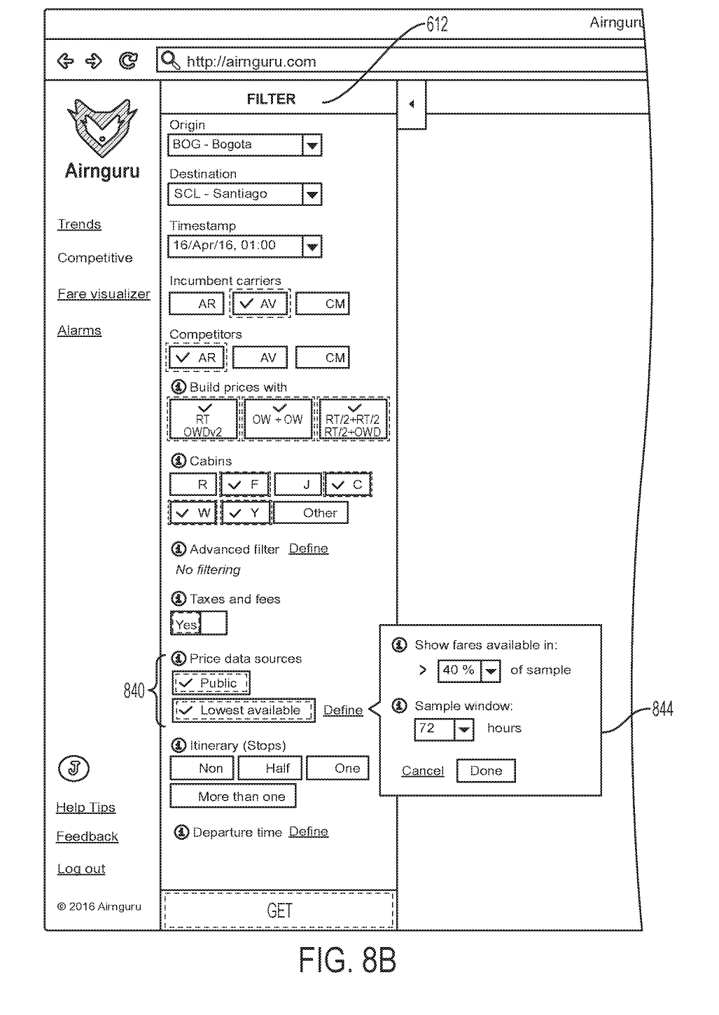

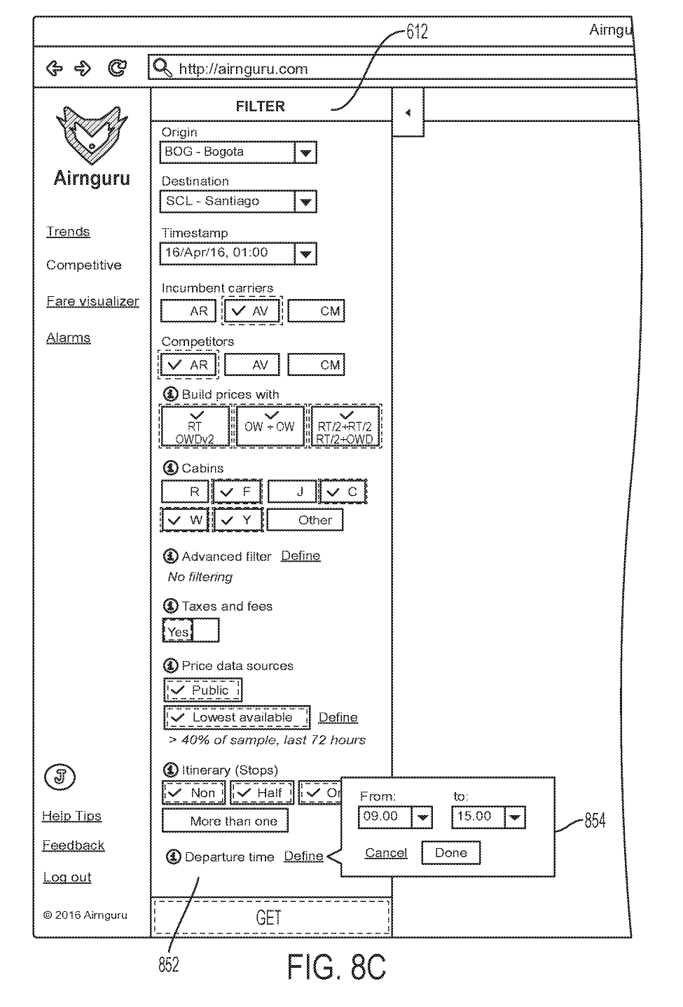

(a) Filter: Through the filter section (see FIG. 8A-8C) the user defines the flight origin 810 and the flight destination 812 forming an origin-destination pair, the sales date and time timestamp 814 (the timestamp represents the date and time of an airfare data update by the data provider), one or more incumbent carriers 820 (an incumbent carrier could be one or more airlines) and one or more competitive carriers 822 to which the one or more incumbent carrier 820 data should be compared. This section offers the user a variety of filters and options to build the prices for round trips 824. These filters and options include at least types of fares and combinations, cabins 826, itinerary types 850 (non-stops, half stops, one stops, etc.; user can de-select itinerary option to evaluate prices assuming there is always and only a nonstop itinerary available per airline), departure time 852, airfare data sources 842 (published fares data, lowest available fares data, etc.; user can select two or more fare data sources to produce added value “intersections” or complementarity), airport taxes 840, etc. Advanced filter 830 can be provided which generates an advanced filter pop-up window 832 which enables the user to include additional filtering criteria.

As shown in FIG. 8B, the price data sources 840 can also provide a price and data source pop-up window 844 for the lowest available airfare data source which allows further selection of airfares that are available for sale in more than a user specified percentage of a sample within a user specified sample window. In FIG. 8C, the departure time 852 can include a departure time pop-up window 854 which allows the user to enter a start time and end time for the departure time.

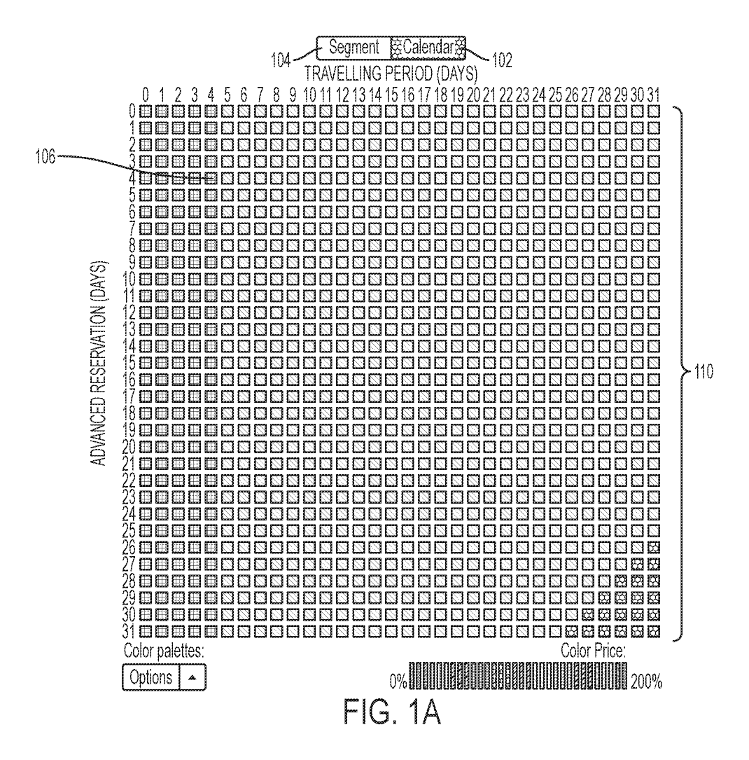

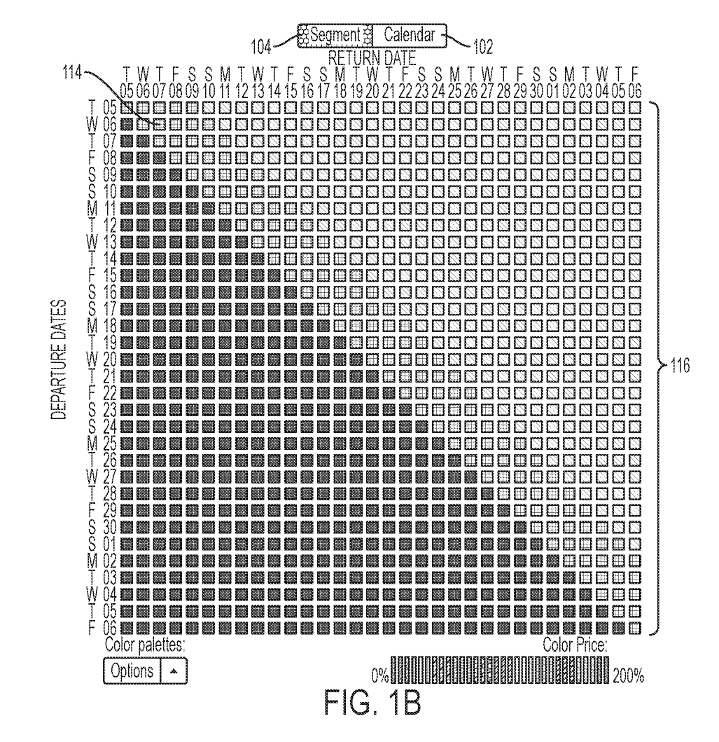

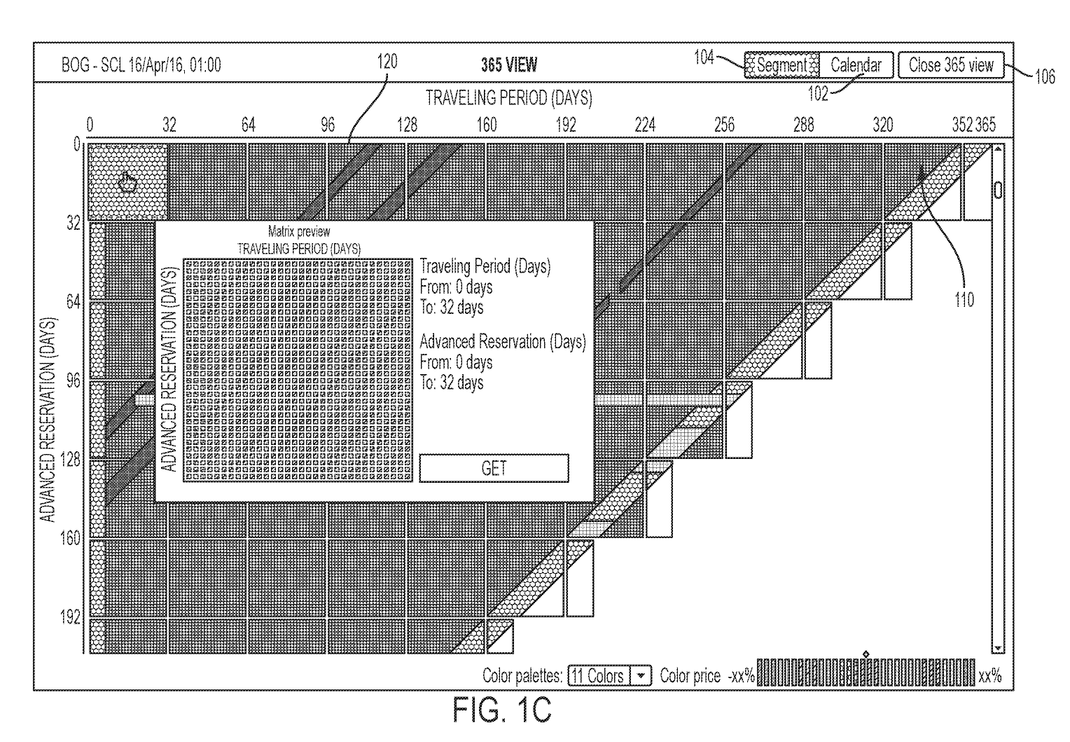

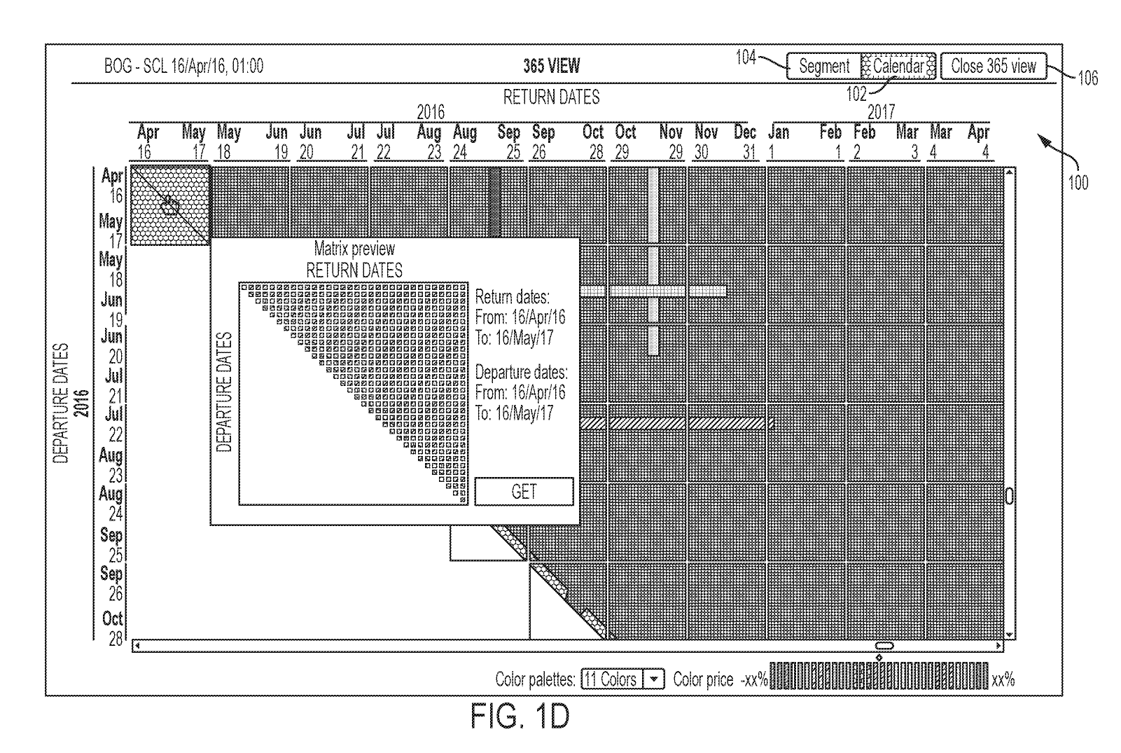

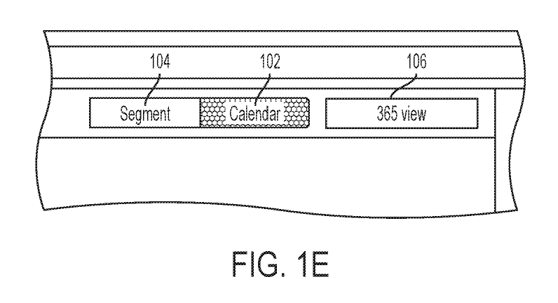

(b) Competitive Position Matrix: In a default view of a competitive position matrix (see FIGS. 1A, 1B) the user can visualize the competitive position for any combination of dates (outbound vs inbound), with a maximum travelling period of, for example, 31 days. The matrix provides a visual representation of competitiveness at each matrix cell level by converting to a color the results of numerically comparing two prices: the lowest applicable price of the incumbent airline(s) versus the lowest price of the competitor airline(s), at each matrix cell level (that is, for example, at the level of each inbound date versus outbound date combination level). The segment view matrix 110, shown in FIGS. 1A-B, can be a sub-matrix to a larger matrix, such as a 365 matrix 120 shown in FIGS. 1C-D.

The numerical comparison between the two prices that is used to determine the color at each matrix cell level may be, for example, the ratio of the two prices. The color assigned to a given price ratio may be retrieved from a spectrum table that univocally relates real numbers with colors or it may be computed with a mathematical function that takes in a real number and produces a color code that is interpreted by the computer. Several spectrum choices may be provided to users, with different numbers of colors or different color ranges. One spectrum may be provided for color blind users. A distinctive color (for example, green or white) may be used at the center or near the center of the spectrum to represent perfect competitiveness (for example, corresponding to a price ratio of exactly 1.0), in order to make it faster for users to discard date combinations with no competitive problem and rather focus their attention on date combinations with competitive problems. For example, if a spectrum of three colors is chosen, e.g., blue, white and red, and, some cells of the matrix have a price ratio of exactly 1.0 (that is, the competitor airline's lowest applicable price in each of those cells divided by the incumbent airline's lowest applicable price in each of those cells equals 1.0), then those cells will be presented to the user as “white” for the relevant matrix cells. If a second group have price ratios larger than 1.0 those cells will be presented as blue for the relevant matrix cells, meaning the incumbent airline is overly competitive in the date combinations corresponding to those matrix cells. If a third group of price ratios are smaller than 1.0 those cells will be presented as red for the relevant matrix cells, meaning the incumbent airline is not competitive in the dates combinations corresponding to those cells. In this way the user immediately finds out all the dates combinations where the airline may be losing market share (red cells) and all the daters combinations where the airline may be diluting potential revenue (blue cells).

A multi-attribute criterion may be used in the numerical comparison instead of just the prices, to determine the competitive position; for example, the duration of the itinerary associated to the price may be incorporated in the numerical comparison. A user defined comparison function, which produces a number from input variables such as prices, itineraries and other product attributes of incumbents and competitors, may also be provided in order to compute the competitive position and, thus, to obtain a color for the matrix cell. In any case, both, the numerical result of the comparison and the corresponding color, may be displayed simultaneously or alternatively at the cell level in the matrix.

The user can toggle between views by selecting a segment view button 104 and/or a calendar view button 102 and/or a 365 view button 106. As shown in FIG. 1A, for a segment view matrix 110, the comparison data between at least a first airfare data set and a second airfare data set is converted from a numerical value, such as a ratio or percentage deviation, into a visual representation and presented in the segment view matrix 110 that has a first axis and a second axis. For example, advanced reservation (number of days prior to travel departure) in one axis (the y-axis as illustrated) and travelling period (number of days at destination) in another axis (the x-axis as illustrated).

Each cell in the resulting segment view matrix 110 in FIG. 1A corresponds to a specific number of days prior to departure for the reservation and a specific number of travelling days or day at the destination (the combination of dates is referred to as a “demand segment.”) The demand segment relates to the way airfare fences are used to segment demand for a particular airfare in the airline business. Typically one airfare fence generates regions of matrix cells associated with that airfare. The system converts the demand segment into a color which is coded to reflect, for example a percent difference between a first data set and a second data set or a ratio between an incumbent airline's lowest prices and one or more competitors' lowest prices. So, for example, the segment matrix cell 112 (4,4) corresponds to airfare data related to a four day travelling period with a reservation made four days in advance of travel.

In FIG. 1B, the calendar view is based on the same information as the “segment view” of FIG. 1A, but time axes are expressed as absolute dates: one axis corresponds to departure dates (illustrated as the y-axis) and another axis corresponds to return dates (illustrated as the x-axis). Thus, for example, a specific calendar matrix cell 114 of the calendar view matrix 116 corresponds to a departure date of Wednesday the 6th and a return of Thursday the 7th.

The default view of the matrix corresponds to a subset of contiguous cells (for example a subset of 32×32 cells in the FIGS. 1A and 1B). From this default view (either in its “segment” or “calendar” views), the user may zoom-out to view a full calendar year by, for example, selecting a 365 view button 106 (see FIGS. 1C and 1E). This gives the user the possibility to choose a different pivot outbound vs. inbound date combination for the competitive position matrix (see FIG. 1C and 1D). Other alternatives to get to future date combinations within the year may include the possibility of the user directly typing in the date ranges that the user wishes to analyze, etc.

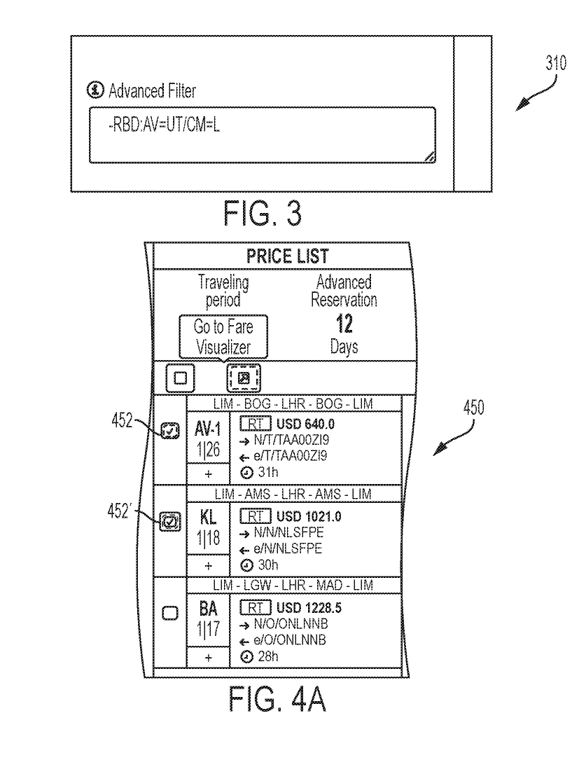

FIG. 3 illustrates an advanced filter 310, where the user can filter-in or filter-out specific airline's RBD's, fare classes, etc. using a string nomenclature that can be provided for the purpose. This is especially useful in low cost markets where no fare fences are present or where the fare fences are weak.

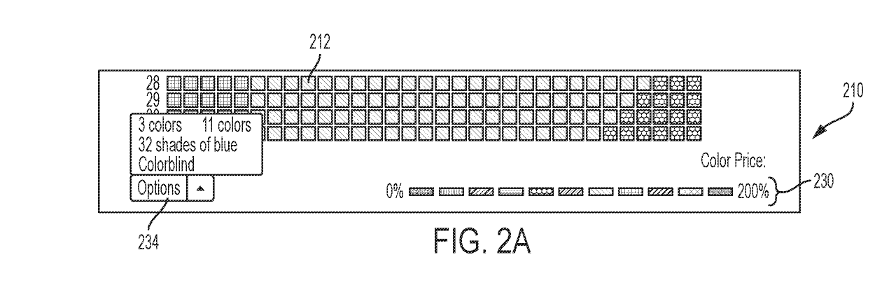

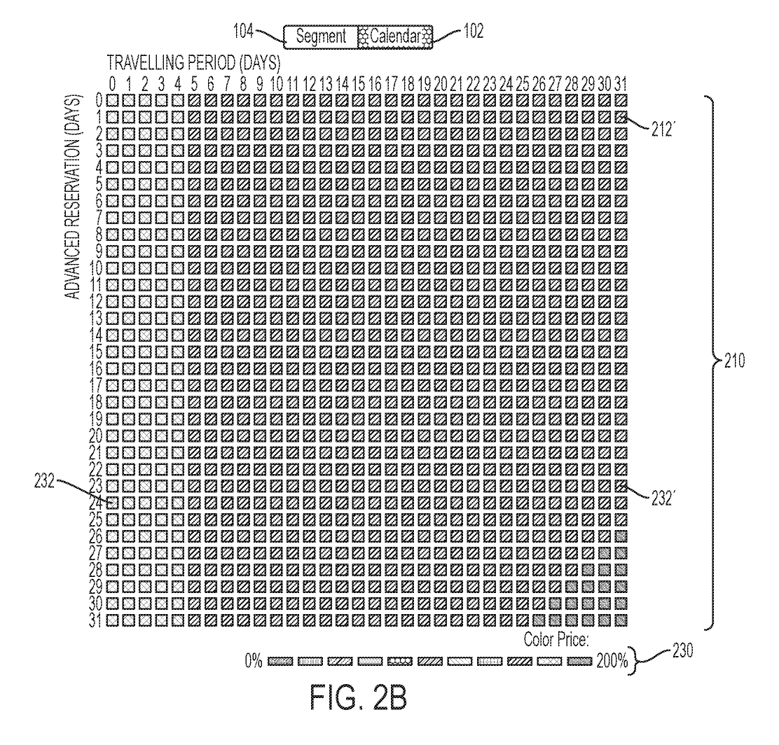

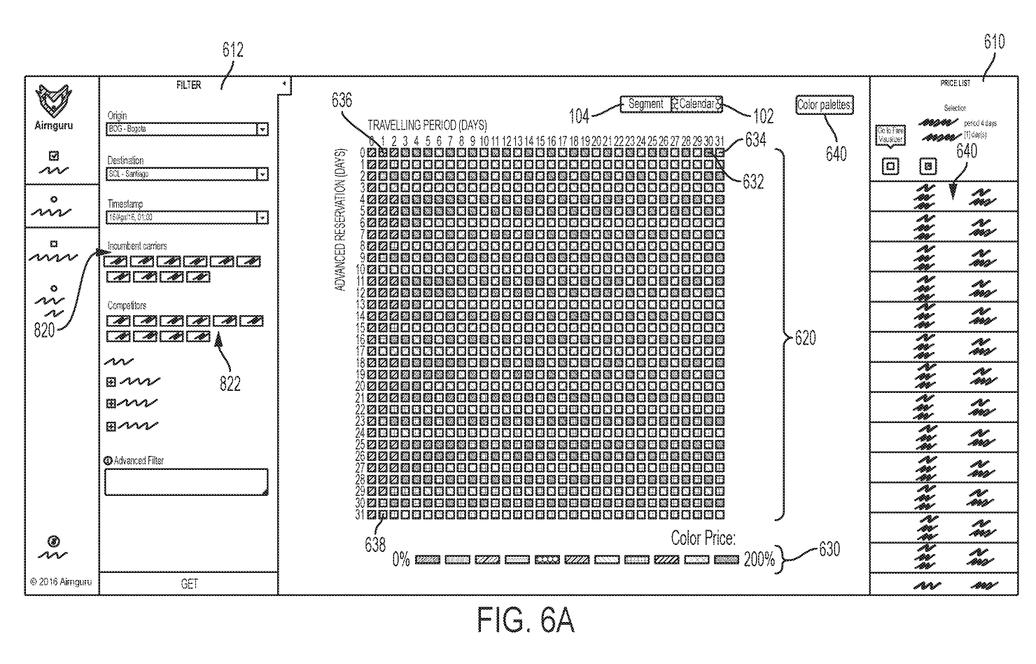

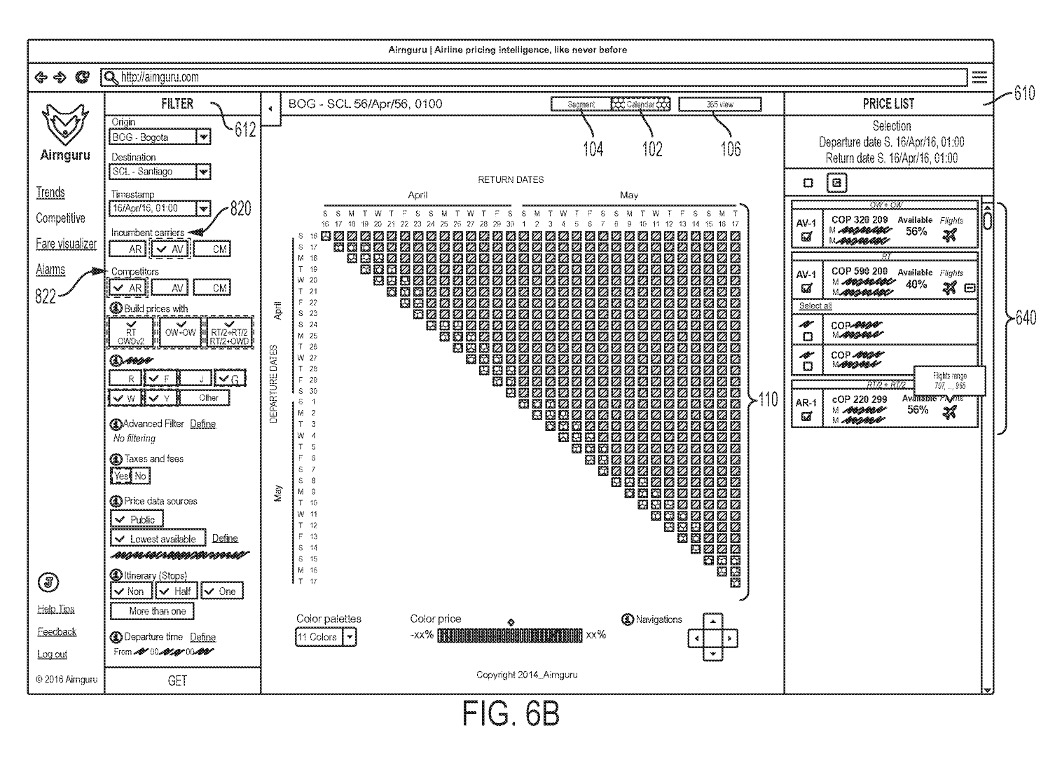

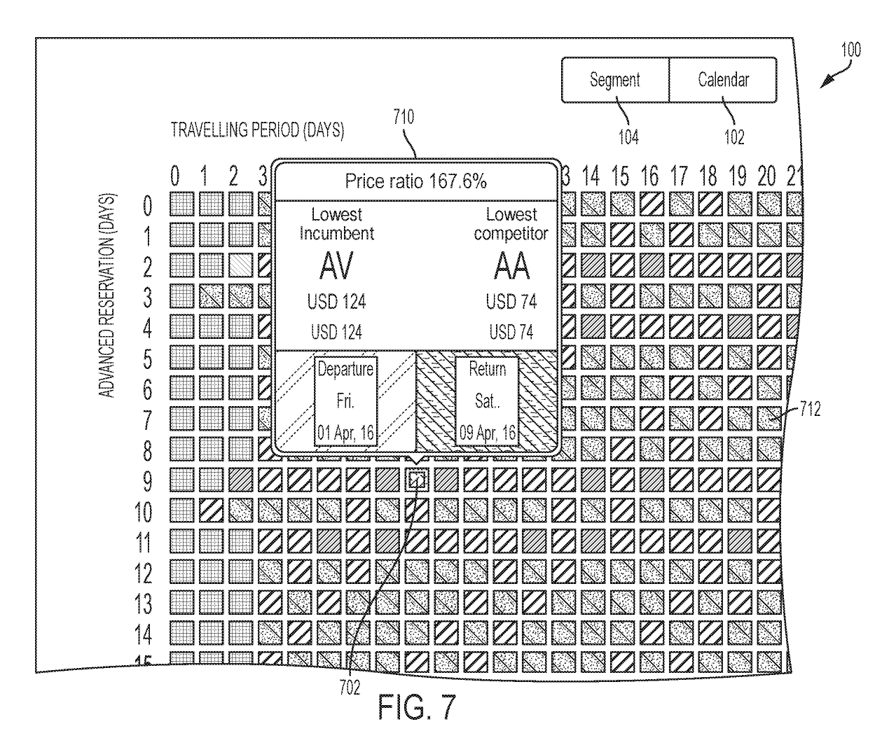

The data representing a competitive position in each cell 212 of the matrix view 210 (corresponding to a specific combination of dates) is expressed via a color. When the user hovers over a specific cell of the competitive position matrix, additional qualitative and quantitative information may be displayed in a tooltip 710 (see FIG. 7), including, for example, the price ratio, the lowest applicable price among incumbents, the lowest applicable price among competitors, the corresponding airlines' codes, departure and return dates. The price ratio may be defined as the competitor(s)' lowest applicable price divided by the incumbent(s)' lowest applicable price for that particular date combination. The color is a mapping of the price ratio into a color spectrum 230. The color spectrum 230 can be different colors or can be different shades of the same color. By visually representing a spectrum (colors or shades), the user can quickly see where opportunities to reduce market share losses by reducing prices can be focused in order to provide a more competitive price and, and where opportunities to increase airfare prices in order to reduce dilution can be focused. The user may select various types of color spectra. For example, matrix color 232, 232′ can be selected from the color spectrum 230 which are shades of the same color. Using shades of the same color for the matrix color 232, 232′ can useful for color blind users (FIG. 2B) and is achievable by changing the color option 234. Alternatively, different colors representing different opportunities can be selected from a color spectrum 630 (e.g., red 632, orange 634, green 636, and yellow 638) as shown in FIG. 6A. A color palette 640 can be provided to allow a user to select from differing color schemes.

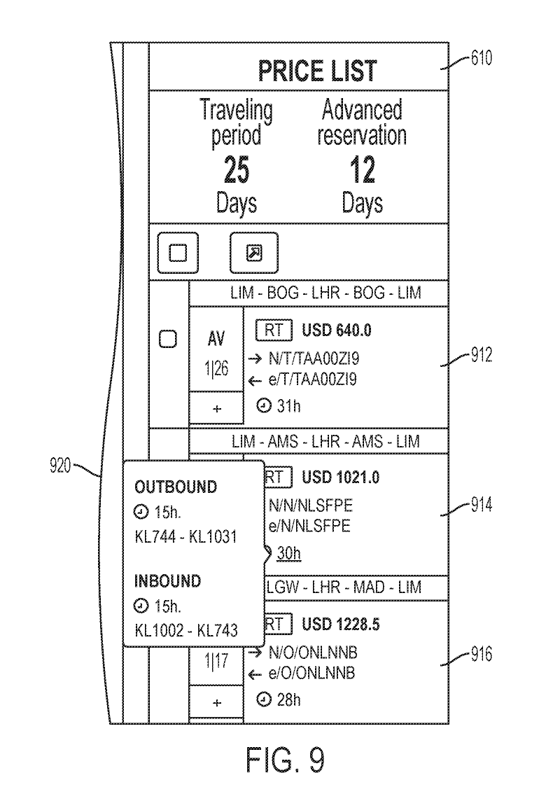

(c) Price List: When clicking on a matrix cell a price list 610 is displayed in a price list section of a competitive analytics module (see FIGS. 6A-B, and FIG. 9). The price list 610 can be positioned on one side of the matrix (FIGS. 6A-B, 11A and 11C). This price list 610 lists a selection criteria 910 and contains a multiplicity of applicable prices 912, 914, 916 for round trips computed for the corresponding date combination. Itinerary pop-up window 920 can be provided for each of the displayed prices, which provides additional detail about the itinerary to which the corresponding price applies. In the case of published fare sources (like ATPCO), prices may be computed from a variety of types of airfares and their combinations, for example, from round trip fares (“RT”), from duplication of one way duplicable fares (“OWD×2”), from combinations of one way fares (“OW+OW”),from combinations of round trip fares (“RT/2+RT/2”) and from combinations of half round trip fares with one-way duplicable fares (“RT/2+OWD”) (See FIG. 8A).

FIG. 4A illustrates a close view of a dynamic link 450, which allows a user to select specific prices 452, 452′ from a price list and export the selected prices along with any active filters in of the competitive analytics module to another module of the suite for further analysis. This avoids the task of retyping the filters in those other modules. FIG. 4B illustrates how the input filter 460 from the dynamic link may be displayed. The input filter 460 can include, for example, destination filter 462, carriers filter 464, fare class filter 466 and OW/RT filter 468.

The competitive position matrixes (FIGS. 1A, 1B , 1C and 1D) provides the user with a quick summary of actionable material in an accessible format:

Visualization of price-competitive position, in a single GUI, using colors (and optionally numbers), across a plurality of combinations of dates (or all possible combinations) of outbound vs. inbound flights, reflecting all demand segments, for a given origin-destination pair, is a high impact, one shot overall diagnoser of a market's situation, saving hours of analysis when compared to legacy fare management systems.

Computation and visualization of lowest applicable prices of incumbent airlines and all its competitors in a given origin-destination pair, for round trips, in a single shot for all possible combinations of dates (outbound vs inbound) within a year from sales date (or the maximum allowed for ticketing by the reservation systems or by published itineraries), using combinations of fares, including round trip fares, one way fares and one way duplicable fares would be a highly expensive and low performance task using traditional/legacy systems.

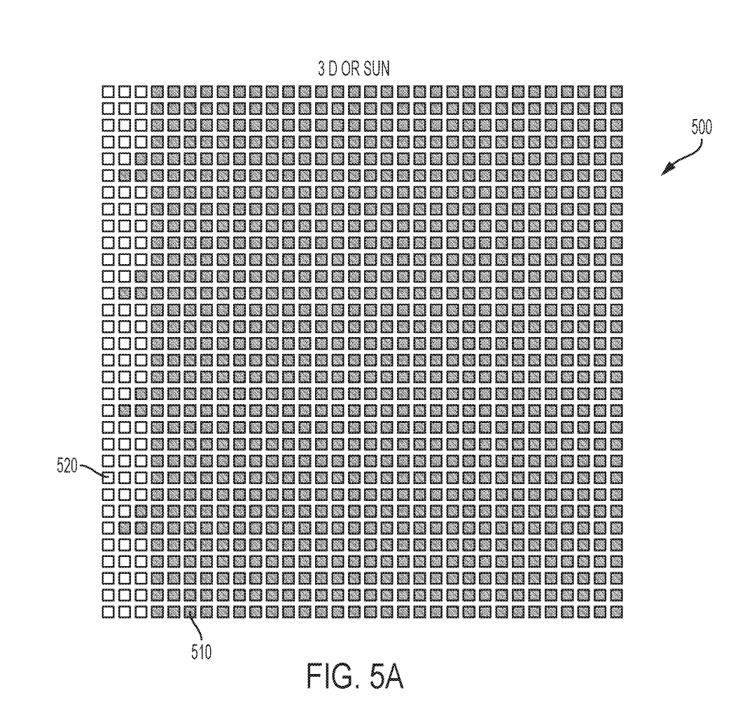

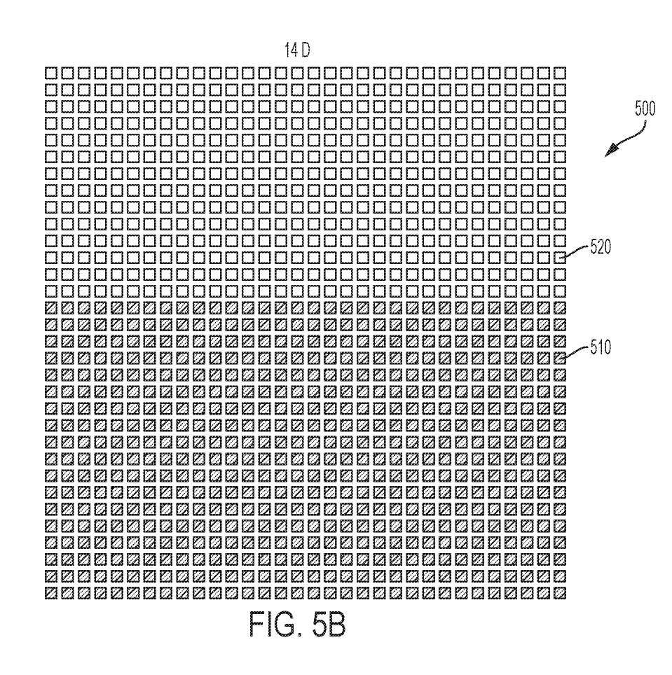

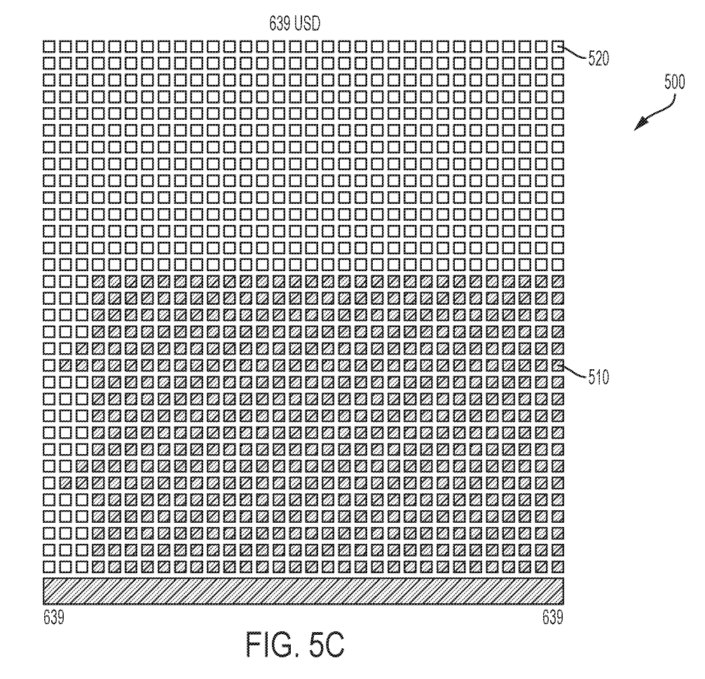

Another feature of the system helps the user drill down to the level of fare fences or fare rules: the segmentation matrix graphically illustrates (see FIGS. 5A-C) the applicability of a fare rule or fare fence on a double date entry matrix analogous to the competitive position matrix. In this case, colored zones of the segmentation matrix mean the fence allows the application of the fare in the corresponding date combinations, whereas uncolored zones correspond to date combinations where the fare is not applicable. The segmentation matrix, which provides a simple, convenient and quick visualization of the impact of a given, single and isolated segmentation rule or “fare fence” on the applicability of the price across different date combinations, will probably influence the decision to purchase a pricing intelligence software/solution. FIG. 5A exemplifies the use of a segmentation matrix to visualize a “3-day or Sunday” minimum stay rule; FIG. 5B exemplifies a “14-day” minimum advanced reservation restriction and FIG. 5C exemplifies the use of the segmentation matrix to visualize the intersection of all rules or fare fences to build the applicable zone of the resulting price. Resulting price may be a range across the matrix, given the interpretation of one or more of the fare rules. The system is configurable to receive data input in multiple formats, including ATPCO and screen scraping data (from providers like INFARE, QL2, etc.), combine and correlate the data and display the combined data in the disclosed formats.

Other features of the system include:

View of price-competitive position at a past sales date with current prices at the time of sales (see timestamp selection combo box on FIG. 8A or on the left side in FIG. 6A, 6B). The competitive position matrix keeps history of competitive position and all fare details. The user can select a plurality of price filters 612, with the calendar view matrix 620 generated, and a detailed price list 642.

The prices computed and visualized in a competitive analytics module can be “all-in” prices optionally incorporating the impact of real itineraries of incumbent airlines and competitor airlines on applicable prices and date combinations (including the YQ/YR component of price, which highly depends on the structure of the real itineraries).

All origin-destinations are updated after the fare data is made available by the corresponding source.

The default fare data source is any published fare data source with real time, almost real time or batch data feed. Optionally, lowest available fare data (for example from screen scraping sources or from reservation systems) may be integrated into the competitive position matrix (see price filters 612 in FIG. 8A), to inform the user whether the lowest applicable fare in a given date combination is also available, what percentage of the time it was available, or other convenient metrics. The price filters 612 can include flight origin 810 (shown as a drop down), flight destination 812 (shown as a drop down), sales date and time timestamp 814 (shown as a drop down), incumbent carriers 820, competitive carriers 822, options of types of fares to build prices for round trips 824 with, cabins 826, advanced filter 830 (which can generate an advanced filter pop-up window 832), airport taxes 840 and fees (shown as a toggle), airfare data sources 842, itinerary stops 850 and departure time 852. The airfare data sources 842 can also generate a data source pop-up window 844 to provide additional guidance to the user. The departure time 852 similarly can provide a departure time pop-up window 854.

Information is displayed/visualized in the competitive position matrix (see FIG. 1A, 1B, 1C and 1D), using two time axis (i.e., advanced reservation vs. travelling period or, alternatively, departing date vs returning date).

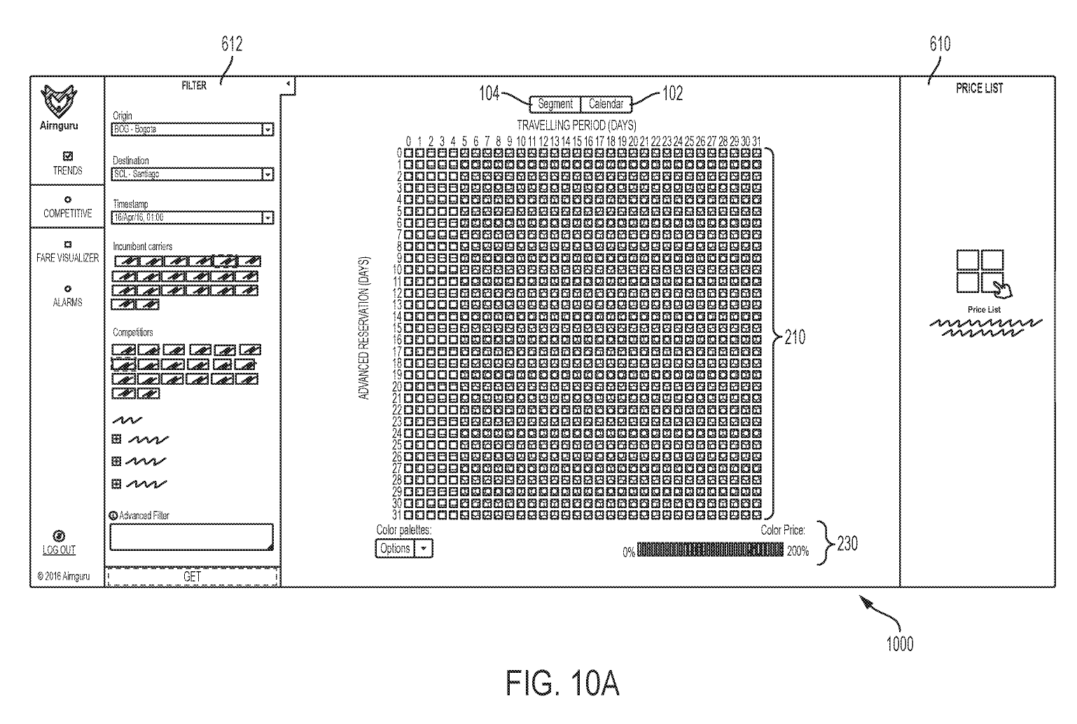

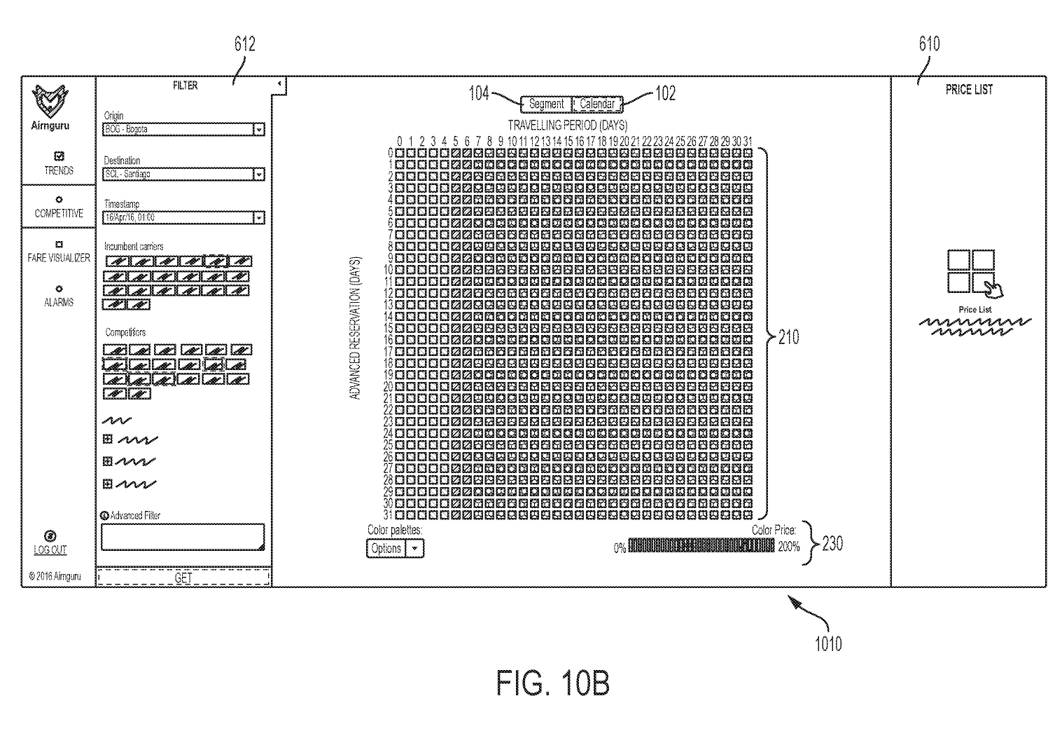

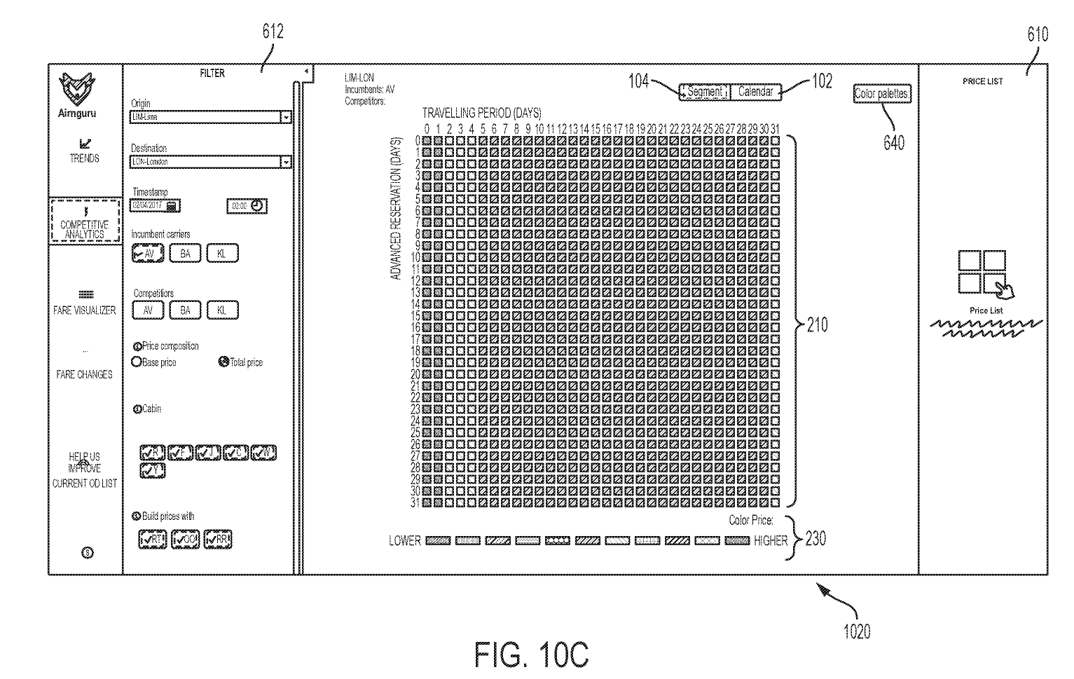

As shown in FIGS. 10A-B, each cell of the matrix 1000, 1010 can be assigned a color which corresponds to the competitiveness of the prices of the incumbent airline(s). Thus, a user can quickly see where in the matrix (i.e., in which date combinations) the prices are competitive and where the prices are not competitive. Selecting, for example by clicking, on a cell within the matrix will launch a detailed view for that cell which includes, as described above, the ratio of the lowest incumbent airline price over the lowest competitor price for that particular departure and return date combination (or reservation anticipation vs travelling period combination) or, optionally, any other useful metric based on prices. As the color of the cells within the matrix change from, for example, blue to red, the prices for the incumbent airline(s) go from competitive (e.g., prices lower than the competitor) to under competitive (i.e., prices above competitor's).

As shown in FIG. 10C, the color spectra for the matrix 1020 in the competitive analytics module may also be used to “self-compare” the price structure of an airline across the competitive matrix, that is, to compare the lowest applicable price of the airline at each cell of the matrix (in other words, at each outbound vs. inbound date combination) with the overall lowest applicable price of the airline for the chosen origin-destination pair.

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

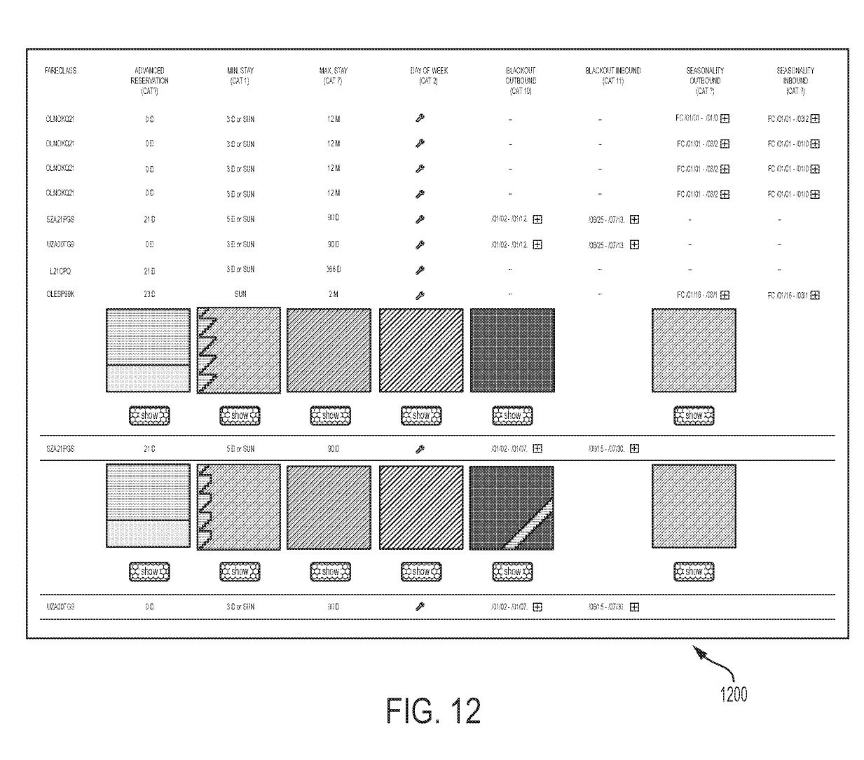

FIG. 12 illustrates another view 1200 of the fare data, a fare visualization of sub-selection of fares applicable in the demand segment selected (clicked) in competitive analytics module, showing the “segmentation matrix” for each fare fence that can be interpreted on a reservation anticipation versus travelling period (or length of stay) matrix.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like. The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at times be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

Additionally, a communication system of the disclosure comprises: a sensor as disclosed; a server computer system; a measurement module on the server computer system for permitting the transmission of a measurement from a detection device over a network; at least one of an API (application program interface) engine connected to at least one of the detection device to create a message about the measurement and transmit the message over an API integrated network to a recipient having a predetermined recipient user name, an SMS (short message service) engine connected to at least one of the system for detecting physiological parameters and the detection device to create an SMS message about the measurement and transmit the SMS message over a network to a recipient device having a predetermined measurement recipient telephone number, an email engine connected to at least one of the detection device to create an email message about the measurement and transmit the email message over the network to a recipient email having a predetermined recipient email address, a web service, an XML engine, and any other way of communicating information and data. Communications capabilities also include the capability to communicate and display relevant performance information to the user, and support both ANT+ and Bluetooth Smart wireless communications. A storing module on the server computer system for storing the measurement in a detection device server database can also be provided. In some system configurations, the detection device is connectable to the server computer system over at least one of a mobile phone network and an Internet network, and a browser on the measurement recipient electronic device is used to retrieve an interface on the server computer system. In still other configurations, the system further comprising: an interface on the server computer system, the interface being retrievable by an application on the mobile device. Additionally, the server computer system can be configured such that it is connectable over a cellular phone network to receive a response from the measurement recipient mobile device. The system can further comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement. Additionally, the system can be configured to comprise: a transmissions module that transmits the measurement over a network other than the cellular phone SMS network to a measurement recipient user computer system, in parallel with the measurement that is sent over the cellular phone SMS network.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for analyzing airline pricing comprising:
(a) receiving a request for a comparison of airline pricing data;
(b) identifying a source for the airline pricing data;
(c) electronically collecting airline pricing data for at least a first airline and a second airline;
(d) comparing the collected airline pricing data to determine a competitiveness of the first airline pricing data to the second airline pricing data;
(e) transforming the compared airline pricing data from a numerical format into a non-numerical format based on a set of rules;
(f) generating, using a computer, a graphical matrix of the compared airline pricing data having a first axis and a second axis wherein each compared pricing data has a cell within the graphical matrix; and
(g) displaying the graphical matrix of compared airline pricing data.

2. The method of claim 1 further comprising comparing the pricing data of the first airline to a pricing data of a third airline.

3. The method of claim 1 wherein the first axis is a traveling period and the second axis is a number of days advanced reservation.

4. The method of claim 1 wherein the first axis is a return date and the second axis is a departure date.

5. The method of claim 1 further comprising filtering the collected airline pricing data.

6. The method of claim 5 wherein filtering is selected from origin, destination, incumbent carrier, competitor carrier, segment, cabin, airfare, number of stops and departure time.

7. The method of claim 5 wherein the filtering is based on an airfare and further wherein the airfare is sampled based on a percentage of deviation.

8. The method of claim 5 wherein the filtering is based on an airfare and further wherein the airfare is sampled based on a window of time.

9. The method of claim 1 wherein the comparing step further comprises at least one of comparing the first airline pricing data to the second airline pricing data and a third airline pricing data, comparing the first airline pricing data and the second airline pricing data to a third airline pricing data, and comparing the first airline pricing data and the second airline pricing data to a third airline pricing data and a fourth airline pricing data.

10. The method of claim 1 wherein selecting a cell of the matrix provides a summary of competitive data selected from a price ratio, a lowest incumbent, a lowest incumbent price, a lowest competitor, a lowest competitor price, a departure data and a return data.

11. The method of claim 1 wherein the airline pricing data comprises at least one of real-time data, and historical data.

12. The method of claim 1 wherein an algorithm engine identifies a competitive pattern and generates a visual matrix.

13. The method of claim 1 wherein the steps (a) through (g) are executed via the computer or a series of computers.

14. The method of claim 1 wherein each cell represents data from three or more sources.

15. The method of claim 14 wherein each cell is expandable to present two or more of a price ratio, a lowest incumbent, a lowest competitor, a departure date and a return date.

16. A data storage and retrieval system for a computer having a memory, a central processing unit and a display comprising:
means for configuring the memory to generate a matrix having a first axis and a second axis, the matrix including
a plurality of cells having a display selected from at least one of three choices based on a plurality of attributes wherein the attributes are selected from incumbent airfare, competitor airfare, departure date, departure time, return date, return time, traveling period, and advanced reservation time.

17. The system of claim 16 further comprising assigning a color to each of the plurality of cells based on a calculated competitiveness of at least one incumbent airfare and at least one competitor airfare.

18. An apparatus for automatically determining competitiveness of airline pricing data comprising:
a computer system;
identifying a source for the airline pricing data;
electronically collecting airline pricing data for at least a first airline and a second airline;
obtaining a first set of rules for comparing the collected airline pricing data to determine a competitiveness of pricing data of the first airline to the pricing data of the second airline;
applying, in the computer system, the first set of rules to generate the competitive pricing data;
applying, in the computer system, a second set of rules for transforming the compared airline pricing data from a numerical format into a non-numerical format;
generating, by the computer system, a graphical matrix of the compared airline pricing data wherein each compared pricing data has a cell and further wherein each cell presents a visual representation of the comparison along a first axis and a second axis; and
displaying the matrix of compared airline pricing data.

19. The apparatus of claim 18 further comprising comparing the pricing data of the first airline to a pricing data of a third airline.

20. The apparatus of claim 18 further comprising filtering, by the computer system, the collected airline pricing data.

21. The system of claim 20 wherein filtering is selected from origin, destination, incumbent carrier, competitor carrier, segment, cabin, airfare, number of stops and departure time.

22. The system of claim 20 wherein the filtering is based on an airfare and further wherein the airfare is sampled based on a percentage of deviation.

23. The system of claim 20 wherein the filtering is based on an airfare and further wherein the airfare is sampled based on a window of time.

24. The system of claim 18 wherein an algorithm engine identifies a competitive pattern and generates the graphical matrix.

25. The system of claim 18 wherein the computer system includes a series of computers.

26. The system of claim 18 wherein each cell represents data from three or more sources.

27. The system of claim 26 wherein each cell is expandable to present two or more of a price ratio, a lowest incumbent, a lowest competitor, a departure date and a return date.
